(19) United States
(12) Patent Application Publication
(10) Pub. No.: US 2008/0170584 A1
(43) Pub. Date: Jul. 17, 2008

(54) Management device, management method, computer readable medium and computer data signal

(75) Inventor: Masahiro Shoji, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 11/892,774

(22) Filed: Aug. 27, 2007

(30) Foreign Application Priority Data
Jan. 17, 2007 (JP) 2007-007894

(51) Int. Cl. H04L 12/42

(52) U.S. Cl. 370/449; 370/241; 726/11

(57) ABSTRACT

A management device comprises: a receiving section that receives, from at least one information processor via a fire wall, a polling signal to inquire if there is a demand to transmit to the information processor; a deciding section that decides a transmission timing of the polling signal due to the information processor; and a transmitting section that transmits a reply to the polling signal that is received by the receiving section, the reply including the transmission timing decided by the deciding section.

### CROSS-REFERENCE TO RELATED APPLICATIONS

This application is based on and claims priority under 35 USC 119 from Japanese Patent Application No. 2007-007894 filed Jan. 17, 2007.

### BACKGROUND

(i) Technical Field

The present invention relates to a management device, a management method, a computer readable medium and a computer data signal.

(ii) Related Art

When a failure occurs in an information processor, a recovery data in order to recover the information processor from this failure may be transmitted to the information processor from an outside management server. In this case, when a fire wall is disposed between the information processor and the management server, even if the management server transmits the recovery data from the management server to the information processor, this is blocked by the fire wall.

### SUMMARY

According to an aspect of the invention, there is provided a management device comprising: a receiving section that receives, from at least one information processor via a fire wall, a polling signal to inquire if there is a demand to transmit to the information processor; a deciding section that decides a transmission timing of the polling signal due to the information processor; and a transmitting section that transmits a reply to the polling signal that is received by the receiving section, the reply including the transmission timing decided by the deciding section.

### BRIEF DESCRIPTION OF THE DRAWINGS

Exemplary embodiments of the present invention will be described in detail based on the following figure, wherein:

FIG. 1 is a system block diagram of a management system according to the present invention;

FIG. 2 is a sequence view showing an examples of the processing by the management system;

FIG. 3 is a view showing an example of a transmission timing of the designated polling signal;

FIG. 4 is a sequence view showing an examples of the processing by the management system;

FIG. 5 is a sequence view showing an examples of the processing by the management system; and

FIG. 6 is a view showing an example of a condition to designate a transmission timing of a polling signal.

### DETAILED DESCRIPTION

Hereinafter, the exemplary embodiment of the invention will be described with reference to the drawings.

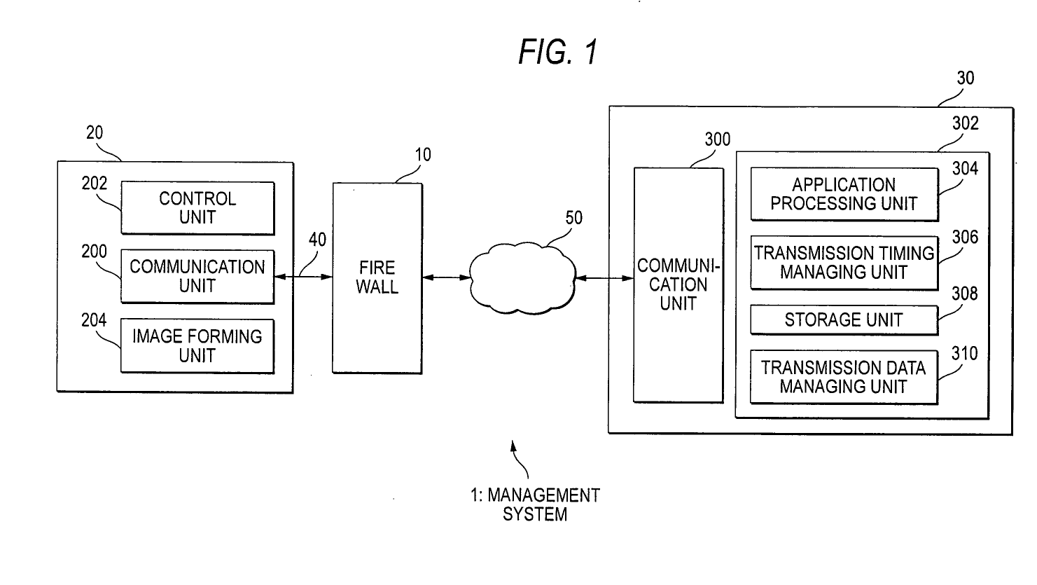

FIG. 1 shows a system block diagram of a management system 1 according to the present exemplary embodiment. As shown in FIG. 1, the management system 1 may include a fire wall 10, a printer 20, and a management server 30.

The printer 20 is connected to a local area network 40, and the management server 30 is connected to an outside network 50. The local area network 40 and the outside network 50 are connected each other via the fire wall 10. Further, the outside network 50 may be determined to be Internet, for example.

According to the present exemplary embodiment, the fire wall 10, the printer 20, and the management server 30 may make communication through a protocol of TCP/IP, respectively. Then, an IP address based on a system of a network in the local area network 40 is allocated to the printer 20. In addition, an IP address based on a system of a network in the outside network 50 is allocated to the management server 30.

The fire wall 10 may control communication made between the local area network 40 to which the printer 20 is connected and the outside network 50 to which the management server 30 is connected. The fire wall 10 is provided being intended to protect the local area network 40 inside of the fire wall from the unauthorized access from the outside network 50 of the outside of the fire wall. As the fire wall 10, a fire wall having a packet filtering function may be used or a fire wall having a proxy function may be used. In addition, the fire wall 10 may be assembled in the printer 20 as software or may be realized as a dedicated hardware (a fire wall server). For example, when the firewall 10 is a server provided with the packet filtering function, communication between the printer 20 and the management server 30 may be controlled as follows.

The fire wall server of a packet filtering type may use an address conversion function together with a packet filtering. The address conversion function is a function to rewrite addresses of a transmission source of the packet and a transmission destination thereof. The address may be designated by an IP address and a port number. For example, according to the management system 1 shown in FIG. 1, when the printer 20 accesses the management server 30 across the fire wall 10, the fire wall server may rewrite the address of the transmission source, namely, the address of the printer 20. Then, if the reply of the packet of which address is converted is returned from the management server 30, the address of the transmission source, namely, the address of the management server 30 may be rewritten by the fire wall server.

Thus, the fire wall server may store an address conversion table in a memory in order to establish the communication via the fire wall. In this address conversion table, an IP address and a port number are stored to convert the IP address and the port number.

The fire wall server can be determined so as to set the IP address and the port number allowing transmission to the printer 20 and interrupt a packet that is directly transmitted from the outside of the fire wall. Thus, a signal transmitted to the printer 20 is interrupted by the fire wall server and it does not attain to the printer 20 using the management server 30 as a starting point. On the other hand, when carrying out polling for the management server 30 from the printer 20 and transmitting the data from the management server 30 to the printer 20 as a reply, it is possible to determine the IP address and the port number to be used for this reply so as to pass through the fire wall server. Thus, a reply signal for polling by means of the management server 30 may attain to the printer 20 without being interrupted by the fire wall server.

Next, the constitution provided to the printer 20 will be described. As shown in FIG. 1, the printer 20 may include a communication unit 200, a control unit 202, and an image forming unit 204. It is assumed that respective units can be communicated each other.

The communication unit 200 may make communication with the management server 30 via the fire wall 10. The communication unit 200 may be realized by means of a network interface. As described above, the communication due to the communication unit 200 may be carried out by a protocol of a TCP/IP.

The communication unit 200 may transmit a polling signal to the management server 30 via the firewall 10. The polling signal is a signal that inquires if there is a demand to transmit to the printer 20. According to the present exemplary embodiment, there are two types in the polling signal, namely, one to be transmitted to the management server 30 at a predetermined period and one to be transmitted to the management server 30 at a transmission timing that is designated by the management server 30. Then, the communication unit 200 may receive a reply signal for the transmitted polling signal from the management server 30. The details of the reply signal from the management server 30 will be described later.

In addition, the communication unit 200 may receive the data of a print job from a client computer (not illustrated) or the like to be connected to the local area network 40 other than the above-described communication processing.

The control unit 202 may include a central processor and may control each unit of the printer 20. The control unit 202 may also control the image forming processing to be made in the image forming unit 204. The control unit 202 may carry out raster processing of the print data that is received from the client computer in the communication unit 200 so as to generate bitmap data. Then, the control unit 202 may transfer the generated bit map data to the image forming unit 204.

In addition, the control unit 202 may transmission of the polling signal to be transmitted to the management server 30. According to the present invention, as control of the polling signal, at least the transmission timing may be controlled.

The transmission timing of the polling signal by the printer 20 may be determined in accordance with a control signal that is included in a reply signal of the polling signal that is transmitted from the management server 30. The control signal may include designation information of the transmission timing for designating at least once transmission timing of the polling signal. The transmission timing may be designated by an absolute time or a relative time, for example, a time after some minutes from the current time.

The image forming unit 204 may form a transcribed image on a photosensitive member on the basis of the bit map data that is transcribed from the control unit 202. Then, the transcribed image formed on the photosensitive member may be transcribed on a print sheet to be fed by a sheet feeding mechanism. The print sheet on which the image is transcribed may be discharged by a sheet discharge mechanism. Thus, the image forming unit 204 may carry out the image forming processing.

Next, the constitution of the management server 30 will be described. As shown in FIG. 1, the management server 30 may include a communication unit 300 and a control unit 302. It is assumed that respective units can make communication with each other. Each unit may be realized by a hardware for constituting a general computer system such as a processor, a memory, a network interface (NIC) or the like.

For example, it is assumed that the communication unit 300 may be realized by an NIC and the communication unit 300 may make communication with other information communication instruments by a protocol of a TCP/IP. Then, in the control unit 302, a CPU (a central processor) may control each unit of the management server 30 in accordance with a command included in a program that is stored in a memory (including a RAM and a ROM or the like) or a hard disk or the like. In addition, the above-described program may be stored in an information memory medium including various formats such as a CD-ROM, a DVD-ROM, a flash memory or others to be provided. In this case, by means of a medium reading apparatus connected to the management server 30, a program is read from the information memory medium. In addition, it may be possible that the program is downloaded via a network.

The communication unit 300 may make the communication with the printer 20 via the fire wall 10. For example, the communication unit 300 may receive the polling signal to be transmitted by the printer 20.

In addition, the communication unit 300 may return a reply signal for the polling signal that is received from the printer 20 to the printer 20 of the transmission source of the polling signal. The reply signal may include a control signal for controlling a transmission timing of the polling signal to be transmitted by the printer 20. The control signal may include designation information of the transmission timing for designating at least once transmission timing of the polling signal.

The control unit 302 may include a CPU (a central processor) and may control each unit of the management server 30 in accordance with a control program that is stored in the memory. Then, the control unit 302 may further include an application processing unit 304, a transmission timing managing unit 306, a storage unit 308, and a transmission data managing unit 310.

The application processing unit 304 may carry out the processing using a polling signal by means of one or plural applications. Here, the processing using the polling signal may include the processing for receiving the data from the printer together with the polling signal and the processing for transmitting the data generated in the application processing unit 304 as the transmission data to the printer including it in a reply signal for the polling signal, for example. Further, the application processing unit 304 may be realized by the operation of the CPU in accordance with a predetermined program to be stored in the memory.

A transmission timing of the polling signal to be transmitted by the printer is designated by each application that is processed in the application processing unit 304. The timing designated by the application may meet a time that the generation processing of the transmission data has been completed, for example.

In the transmission timing managing unit 306, on the basis of a transmission timing of the polling signal that is designated by each application to be processed in the application processing unit 304, a transmission timing of the polling signal to be designated for the printer 20 is decided. As the transmission timing of the polling signal, a transmission timing that is the nearest to the current time may be selected from among transmission timings designated by the application, for example. The details of selection of this transmission timing will be described later.

In the storage unit 308, transmission data that is generated by each application to be processed by the application processing unit 304 may be stored. To the transmission data to be stored, its transmission destination is related. Then, the transmission data to be stored in the storage unit 308 may be transmitted included in the reply of the polling signal after being read by the CPU.

The transmission data managing unit 310 may manage the transmission data to be transmitted being included in the reply of the polling signal from the printer 20. In the case that the transmission data excesses a data size allowed as the reply of the polling signal, the transmission data managing unit 310 may divide the transmission data at an appropriate data position. In addition, the transmission data managing unit 310 may determine if there is the transmission data that has not been transmitted yet in the storage unit or not. Then, when the transmission data managing unit 310 determines that there is the transmission data that has not been transmitted yet in the storage unit, the transmission data managing unit 310 may demand continuous transmission of the polling signal by the printer 20 from the transmission timing managing unit 306.

Receiving a demand of a transmission timing of the polling signal from the transmission data managing unit 310, the transmission timing managing unit 306 may transmit a control signal for designating a transmission timing of a next palling signal, for example, a control signal to designate a transmission timing that is determined after a predetermined time from the current time being included in a reply of the polling signal from the printer 20. For example, a predetermined time may be a short time about five minutes, and it is preferable that this predetermined time is determined in a shorter time interval as compared to a transmission interval of a cyclic polling signal.

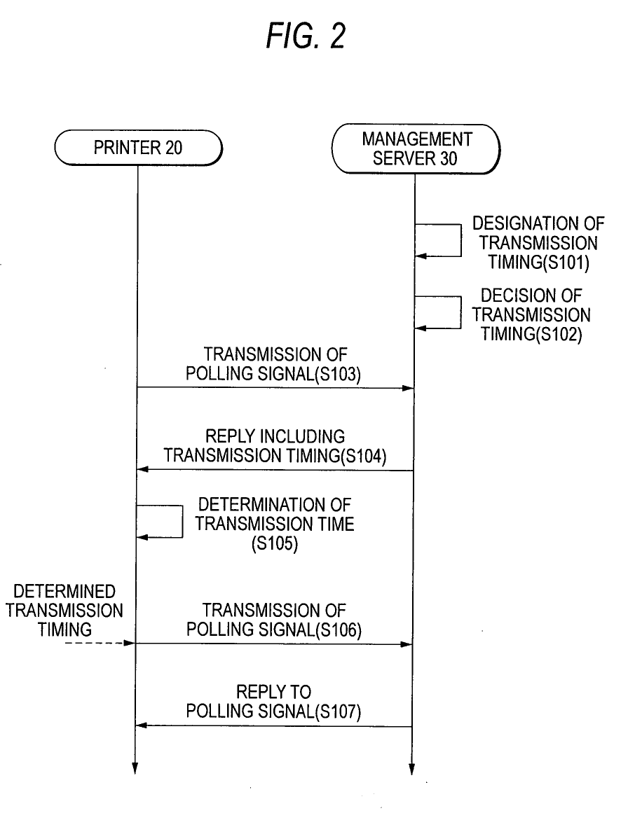

Hereinafter, with reference to a sequence view shown in FIG. 2, an example of the processing in the management system 1 will be described.

The management server 30 may carry out the processing by one or plural applications. Then, each application may designate the transmission timing of the polling signal by means of the printer 20 (S101). The timing designated by the application may be determined to correspond to a time when the generation processing of the transmission data has been completed, for example.

The timing managing unit 306 may decide a transmission timing of a polling signal that is designated for the printer 20 on the basis of the timing that is designated by the above-described each application (S102). Hereinafter, the decision processing of the transmission timing will be described by using a specific example.

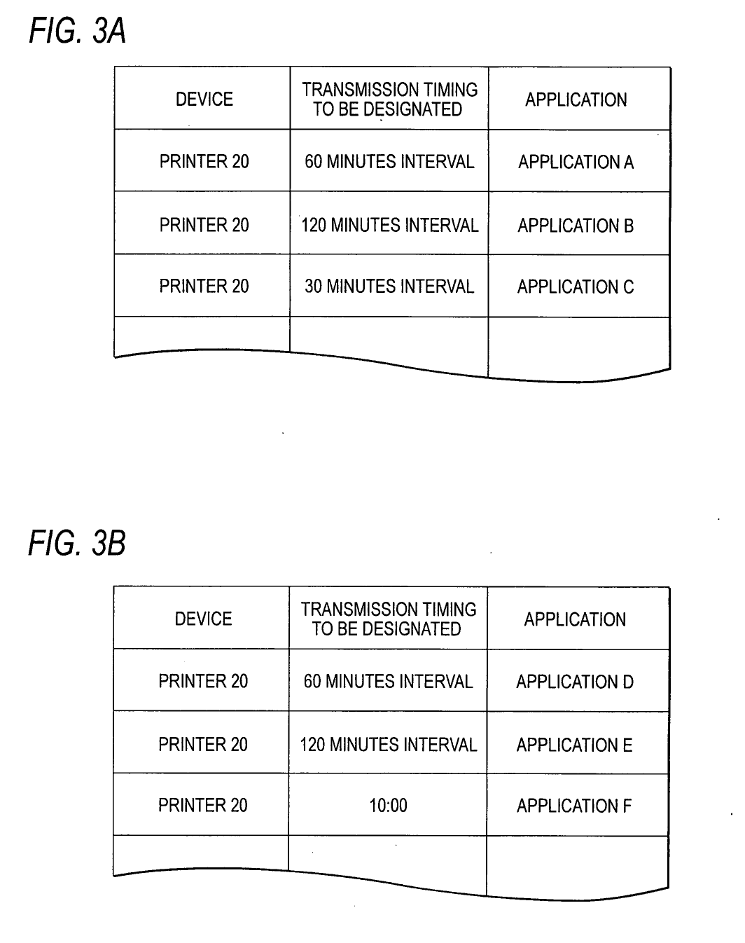

FIG. 3 shows an example of a transmission timing of a polling signal that is designated by each of a plurality of applications. In FIG. 3, the transmission timing of the polling signal is designated by a transmission interval (a time period) or a time. Then, in the case of defining the transmission timing of the polling signal as a timing closest to the current time, according to each example shown in FIG. 3, the transmission timing will be decided as follows.

According to the example shown in FIG. 3(A), a time to be designated by applications A, B, and C is “60 minutes interval”, “120 minutes interval”, and “30 minutes interval”, so that “a time after 30 minutes” will be selected as a transmission timing in accordance with “30 minutes interval” of the application C closest to the current time among them. Then, in the case that a demand due to the application C is cancelled, a time that is a next early time is selected.

Then, according to the example shown in FIG. 3(B), the transmission interval and the time are mixed in designation due to the application in such a manner that “60 minutes interval”, “120 minutes interval”, and “10:00” are designated by the applications D, E, and F, respectively. Here, in the case that the current time is determined to be 9:30, as the timing closest to the current time, “10:00” to be designated by the application F will be selected. Next, in the case that the polling signal is transmitted from the printer 20 at 10:00, “11:00” after 60 minutes will be decided as a transmission timing.

The polling signal is transmitted from the printer 20 (S103) Here, the polling signal to be transmitted may be a signal to be transmitted at a transmission timing that is designated by the management server 30 or may be a signal to be transmitted from the printer 20 at a predetermined period. Then, the management server 30 may receive the polling signal that is transmitted from the printer 20.

The management server 30 may send a reply to the polling signal that is received from the printer 20 including a control signal for designating a transmission timing of the polling signal that has been designated in advance to the printer 20 (S104).

The printer 20 may receive the reply that is transmitted from the management server. Then, on the basis of the control signal to designate the transmission timing included in the reply, a transmission timing of a polling signal to be transmitted next will be determined (S105).

The printer 20 may send the polling signal in accordance with the determined transmission timing (S106). Then, the printer 20 may receive a reply signal for the polling signal from the management server 30 (S107). Here, in the case that the transmission timing to designate the transmission timing for the printer 20 is decided, the control signal to designate the transmission timing for the reply signal may be included.

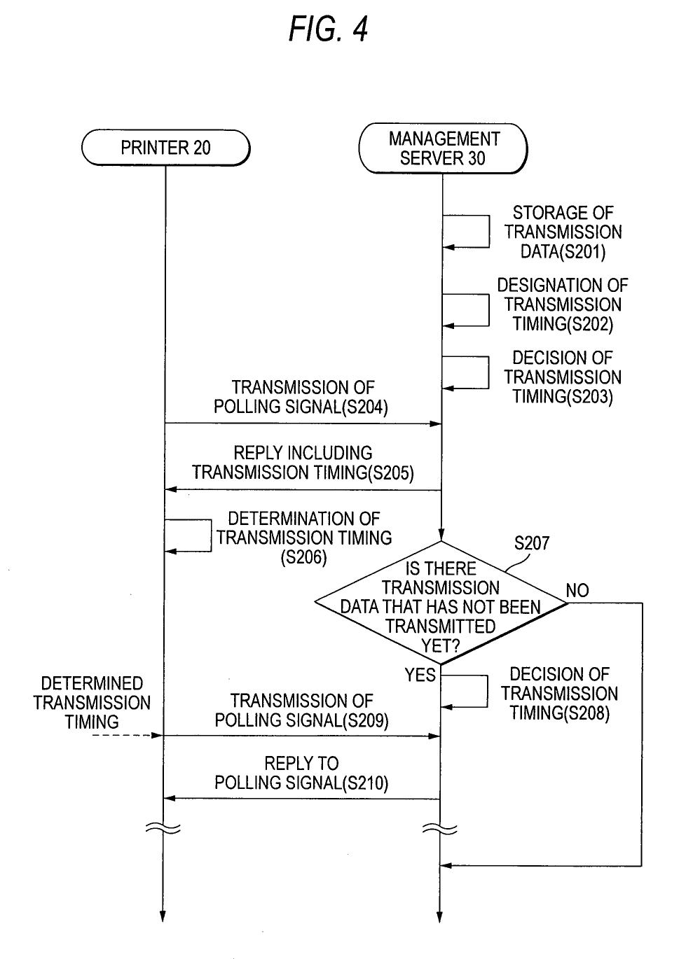

Next, with reference to a sequence diagram shown in FIG. 4, other example of the processing to be carried out in the management system 1 will be described.

The management server 30 may carry out the processing by means of one or plural applications. Then, the transmission data generated by at least one application is stored in the memory (S201). This transmission data may be stored in the memory relating to a device of a transmission destination (according to the present exemplary embodiment, it is the printer 20).

Then, due to each application, a transmission timing of a polling signal by means of the printer 20 is designated (S202). The timing to be designated by the application may correspond to a time when the generation processing of the transmission data has been completed, for example.

The transmission timing managing unit 306 may decide a transmission timing of a polling signal to be designated for the printer 20 on the basis of the timing that is designated by the above-described application (S203).

From the printer 20, the polling signal is transmitted (S204) Here, a polling signal to be transmitted may be a signal to be transmitted at the transmission timing that is designated by the management server 30 or a signal to be transmitted from the printer 20 at a predetermined period. Then, the management server 30 may receive the polling signal that is transmitted from the printer 20.

The management server 30 may send a reply to the polling signal that is received from the printer 20 including a control signal for designating a transmission timing of the polling signal that has been designated in advance to the printer 20 (S205).

The printer 20 may receive the reply that is transmitted from the management server 30. Then, on the basis of the control signal to designate the transmission timing included in the reply, a transmission timing of a polling signal to be transmitted next will be determined (S206).

Here, the management server 30 may determine if there is the transmission data that has not been transmitted yet in the printer 20 or not (S207). Whether or not there is the transmission data that has not been transmitted yet may be determined depending on if the transmission data stored in the storage unit 308 as the data to be transmitted to the printer 20 remains or not.

In the case that it is determined that there is the transmission data that has not been transmitted yet in the printer 20 due to the above-described judgment (S207: Y), the management server 30 may decide a transmission timing of a polling signal designated for the printer 20 (S208). The transmission timing to be decided may be determined after a predetermined time from the current time, for example, after five minutes from the present time.

Then, the printer 20 may transmit the polling signal on the basis of the determined transmission timing (S209) and as its reply, the printer 20 may transmit a reply signal including a control signal designating the transmission timing (S210). The above-described processing may be continued till there is no transmission data that has not been transmitted yet in the printer 20.

The present invention is not limited to the above-described exemplary embodiment. A modification example of this above-described exemplary embodiment will be described below.

It may be assumed that the management server 30 monitors the load of the management server 30 and in accordance with the load that is monitored, the transmission timing designated for the printer is decided. The load of the management server 30 may be decided in accordance with a CPU load, a frequency and a waiting time of a memory access, and a communication load or the like or it may be decided in accordance with a frequency of a polling signal to be received from the printer 20.

For example, in the case that the load of the management server 30 is decided in accordance with the frequency of the polling signal to be received from the printer 20, a load may be decided in accordance with the number of reception of the polling signal to be transmitted from the printer 20 (or other information processor) during a predetermined time (for example, after an hour) Then, determining if the number of reception of the polling signal that is predicted or measured during a predetermined time exceeds a threshold or not, and then, in the case that it is determined that the number of reception of the polling signal that is predicted or measured during a predetermined time exceeds a threshold, the management server 30 may be controlled so as not to designate the transmission timing of the polling signal by the printer 20 during a predetermined time after the present moment.

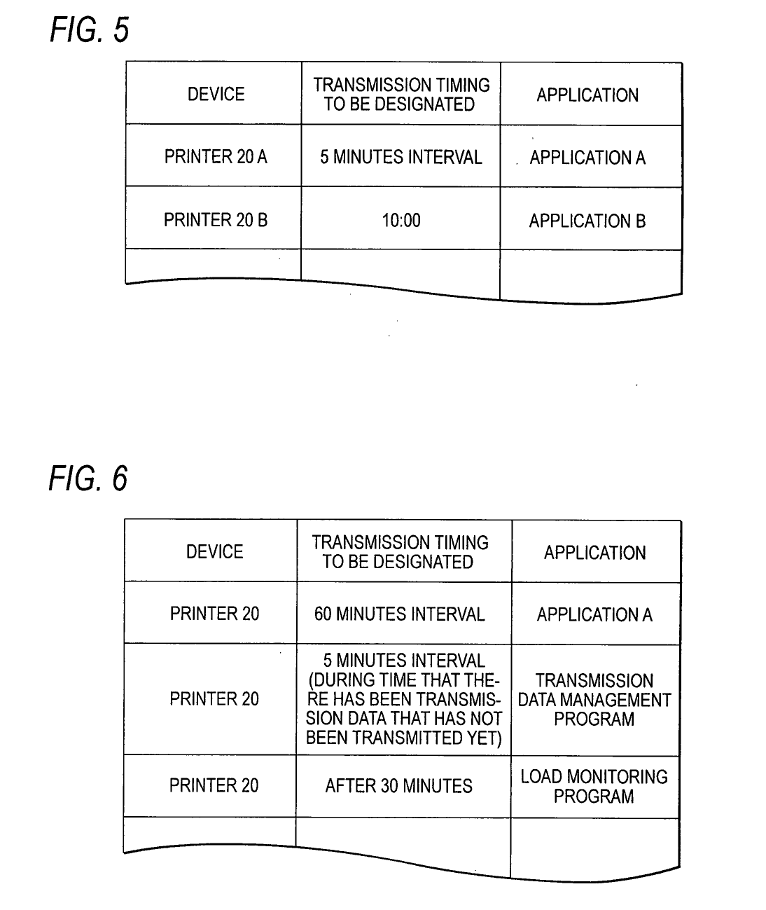

With reference to FIG. 5, on the basis of the load of the management server 30, the processing for deciding the transmission timing of the polling signal will be described using a specific example. In the following example, it is assumed that the load of the management server 30 is high and the management server 30 is controlled so as not to accept polling within 30 minutes.

FIG. 5 shows a transmission timing that is designated by each of one or plural applications. As shown in FIG. 5, it is assumed that a transmission timing of a polling signal is designated “five minutes interval” for the printer 20 by the application A. In this case, if the current time is 9:45, due to the load of the management server 30, it is inhibited to designate the transmission timing of the polling signal within 30 minutes, so that the time such as 9:50, 9:55 or the like that is five minutes interval from 9.45 is not designated. Then, 10:15 after 30 minutes from the present time whereby an inhibition time due to the load is solved is decided as a transmission timing. Here, for example, in the case that the transmission timing of the polling signal is designated “45 minutes interval” for the printer 20 by the application A, since 30 minutes that is the inhibition time due to the load have already passed from the present time, “10:30” is decided as a transmission timing in accordance with “45 minutes interval” that is designated by the application A.

In addition, as shown in FIG. 5, in the case that the application B designates the transmission timing of the polling signal, since “10:00” is within 30 minutes from the present time of “9:45”, namely, within a time range that is inhibited due to the load, “10:15” that is beyond that time range is decided as a transmission timing.

In addition, when deciding the transmission timing, this decision may depend on a priority of each condition as follows. In other words, a priority is given to a transmission timing designated by the application, a time range inhibited due to a load condition, and a transmission timing designated when the transmission data remains, respectively, and depending on this, the transmission timing may be decided.

For example, FIG. 6 shows an example of the above-described respective conditions. According to the example shown in FIG. 6, if a top priority is given to the time range inhibited due to the load, the transmission timing is decided as “a time after 30 minutes” although the application A and the transmission data that has not been transmitted yet remain. On the other hand, in the case that the top priority is given to that the transmission data has been completely and rapidly transmitted to the printer 20, the transmission data is defined as “the time after 5 minutes” regardless of the time range that is inhibited depending on the application A and the load condition. Giving the priority to each condition in this way, the transmission timing may be decided in accordance with the given priority.

In addition, according to the above-described exemplary embodiment, the management server 30 designates the transmission timing of the polling signal to be transmitted next for the printer 20, however, it is possible to designate plural numbers of transmission timings as a whole.

In addition, the present invention is not limited to a printer (an image processor), but it is obvious that the present invention can be used when designating the transmission timing of the polling signal for other information processor such as a personal computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A management device comprising:
a receiving section that receives, from at least one information processor via a fire wall, a polling signal to inquire if there is a demand to transmit to the information processor;
a deciding section that decides a transmission timing of the polling signal due to the information processor; and
a transmitting section that transmits a reply to the polling signal that is received by the receiving section, the reply including the transmission timing decided by the deciding section.

2. The management device according to claim 1, further comprising at least one processing section that carries out processing by using the polling signal received from the information processor,
wherein each of said least one information processor comprises a designating section that designates a transmission timing of the polling signal due to the information processor, and
wherein the deciding section decides the transmission timing of the polling signal that is designated by any one of said at least one designating section.

3. The management device according to claim 1,
wherein the deciding section decides the transmission timing of the polling signal that is selected, in accordance with a predetermined condition, from among transmission timing(s) designated by at least one processing section.

4. The management device according to claims 1, further comprising a monitoring section that monitors a load of the management device,
wherein the deciding section decides the transmission timing of the polling signal based on the load to be monitored by the monitoring section.

5. The management device according to claim 4,
wherein the load of the management device is decided based on a frequency of the polling signal to be received from the information processor.

6. The management device according to claim 1, further comprising a storing section that stores transmission information to be transmitted to the information processor,
wherein the deciding section decides the transmission timing of the polling signal in the case that at least a part of the transmission information to be stored in the storing section has not been transmitted yet.

7. A management method comprising:
receiving, from at least one information processor via a fire wall, a polling signal to inquire if there is a demand to transmit to the information processor;
deciding a transmission timing of a polling signal due to the information processor; and
transmitting a reply to the polling signal that is received by the receiving section, the reply including the transmission timing decided by the deciding section.

8. A computer readable medium storing a program causing a computer to execute a process for managing, the process comprising:
receiving, from at least one information processor via a fire wall, a polling signal to inquire if there is a demand to transmit to the information processor;
deciding a transmission timing of a polling signal due to the information processor; and
transmitting a reply to the polling signal that is received by the receiving section, the reply including the transmission timing decided by the deciding section.

9. A computer data signal embodied in a carrier wave for enabling a computer to perform a process for managing, the process comprising:
receiving, from at least one information processor via a fire wall, a polling signal to inquire if there is a demand to transmit to the information processor;
deciding a transmission timing of a polling signal due to the information processor; and
transmitting a reply to the polling signal that is received by the receiving section, the reply including the transmission timing decided by the deciding section.

10. A management device comprising:
receiving means for receiving, from at least one information processor via a fire wall, a polling signal to inquire if there is a demand to transmit to the information processor;
deciding means for deciding a transmission timing of the polling signal due to the information processor; and
transmitting means for transmitting a reply to the polling signal that is received by the receiving means, the reply including the transmission timing decided by the deciding means.
